(19) United States
(12) Patent Application Publication
(10) Pub. No.: US 2025/0267492 A1
(43) Pub. Date: Aug. 21, 2025

(54) COMMUNICATION METHOD AND COMMUNICATION APPARATUS FOR SENSING MEASUREMENT REPORTING

(71) Applicant: Beijing Xiaomi Mobile Software Co., Ltd., Beijing (CN)

(72) Inventor: Xiandong DONG, Beijing (CN)

(21) Appl. No.: 18/857,411

(22) PCT Filed: Apr. 21, 2022
(86) PCT No.: PCT/CN2022/088208

§ 371 Date: Oct. 16, 2024

(51) Int. Cl. H04W 24/10; H04B 7/06

(52) U.S. Cl. CPC H04W 24/10; H04B 7/0626

(57) ABSTRACT

The present disclosure provides a communication method and a communication apparatus for sensing measurement reporting. The communication method comprises: respectively receiving, from one or more station devices, values for feeding back channel attributes; and on the basis that at least one of the values is greater than or equal to a threshold, sending a trigger frame to at least one of the one or more station devices, so as to trigger the at least one station device to report a sensing measurement result.

### CROSS REFERENCE TO RELATED APPLICATION

The present application is a U.S. National Stage of International Application No. PCT/CN2022/088208, filed on Apr. 21, 2022, the content of which is incorporated herein by reference in its entirety.

### TECHNICAL FIELD

The present disclosure relates to the field of wireless communications, and more specifically, to a communication method and a communication apparatus for sensing measurement reporting.

### BACKGROUND

Wireless Local Area Network (WLAN) has the characteristics of flexibility, mobility and low cost, and so on. With the developments of communication technologies and the growth of user demands, studies regarding applications of WLAN are gradually pushed further. For example, WLAN sensing is currently being studied, and its main application scenarios are: location discovery in dense environments (home environment and enterprise environment), proximity detection, and presence detection and so on.

### SUMMARY

According to an example embodiment of the present disclosure, a communication method for sensing measurement reporting is provided. The communication method is applied in an access point and includes: receiving values for feeding back a channel attribute from one or more stations, respectively; and based on at least one of the values greater than or equal to a threshold, sending a trigger frame to at least one station of the one or more stations to trigger the at least one station to report a sensing measurement result.

According to an example embodiment of the present disclosure, a communication method for sensing measurement reporting is provided. The communication method is applied in a station (STA) and includes: sending a value for feeding back a channel attribute to an access point (AP); receiving a trigger frame sent by the AP, wherein the trigger frame is determined to be sent based on the value greater than or equal to a threshold; and determining whether to send a sensing measurement result to the AP based on the trigger frame.

According to an example embodiment of the present disclosure, a communication apparatus is provided. The communication apparatus is applied in an access point device and includes: a transceiving module configured to: receive values for feeding back a channel attribute from one or more stations, respectively; and based on at least one of the values greater than or equal to a threshold, send a trigger frame to at least one station of the one or more stations d to trigger the at least one station to report a sensing measurement result.

According to an example embodiment of the present disclosure, a communication apparatus is provided. The communication apparatus is applied in a station device and includes: a transceiving module configured to: send a value for feeding back a channel attribute to an access point (AP); and receive a trigger frame sent by the AP, wherein the trigger frame is determined to be sent based on the value greater than or equal to a threshold; and a processing module configured to: determine whether to send a sensing measurement result to the AP based on the trigger frame.

According to an example embodiment of the present disclosure, an electronic apparatus is provided. The electronic apparatus includes a memory, a processor, and a computer program which is stored in the memory and can be run on the processor. When the processor executes the computer program, the methods described above are implemented.

According to an example embodiment of the present disclosure, a computer-readable storage medium is provided. A computer program is stored on the computer-readable storage medium. When the computer program is executed by a processor, the methods described above are implemented.

### BRIEF DESCRIPTION OF THE DRAWINGS

The above and other features of the embodiments of the present disclosure will become more apparent from detailed descriptions of the example embodiments of the present disclosure with reference to the accompanying drawings, in which:

FIG. 1 shows an example approach of WLAN sensing according to an example embodiment.

FIG. 2 is a flowchart illustrating a communication method according to an example embodiment.

FIG. 3 is a flowchart illustrating a communication method according to an example embodiment.

FIG. 4 is a flowchart illustrating a communication method according to an example embodiment.

FIG. 5 is a flowchart illustrating interactions according to an example embodiment.

FIG. 6 is a flowchart illustrating another communication method according to an example embodiment.

FIG. 7 is a block diagram illustrating a communication apparatus according to an example embodiment.

### DETAILED DESCRIPTION

The following descriptions with reference to the accompanying drawings are provided to help fully understand the various embodiments of the present disclosure as defined by the appended claims and their equivalents. The various embodiments of the present disclosure include various specific details, but these specific details are considered to be illustrative only. In addition, for the sake of clarity and brevity, the descriptions of well-known technologies, functions and configurations may be omitted.

The terms and words used in the present disclosure are not limited to the literal meanings, but are only used by the inventor to enable a clear and consistent understanding of the present disclosure. Therefore, for those skilled in the art, the descriptions of various embodiments of the present disclosure are provided only for the purpose of illustration, not for the purpose of limitation.

It should be understood that, unless the context clearly indicates otherwise, the singular forms “a/an”, “one”, “said” and “the” used herein may also include plural forms. It should be further understood that the term “comprise/include” used in the present disclosure refers to the presence of described feature(s), integer(s), step(s), operation(s), element(s) and/or component(s), but does not exclude the presence or addition of one or more other features, integers, steps, operations, elements, components and/or groups thereof.

It should be understood that although the terms “first”, “second”, etc. may be used herein to describe various elements, these elements should not be limited by these terms. These terms are only used to distinguish one element from another element. Therefore, without departing from the teachings of the example embodiments, a first element discussed below may be referred to as a second element.

It should be understood that when an element is referred to as being “connected” or “coupled” to another element, it may be directly connected or coupled to another element, or there may be intermediate element(s). In addition, “connected” or “coupled” as used herein may include a wireless connection or wireless coupling. The term “and/or” or the expression “at least one of . . . ” as used herein includes any and all combinations of one or more of associated listed items.

Unless otherwise defined, all terms (including technical and scientific terms) used herein have the same meaning as commonly understood by one of ordinary skill in the art to which the present disclosure belongs.

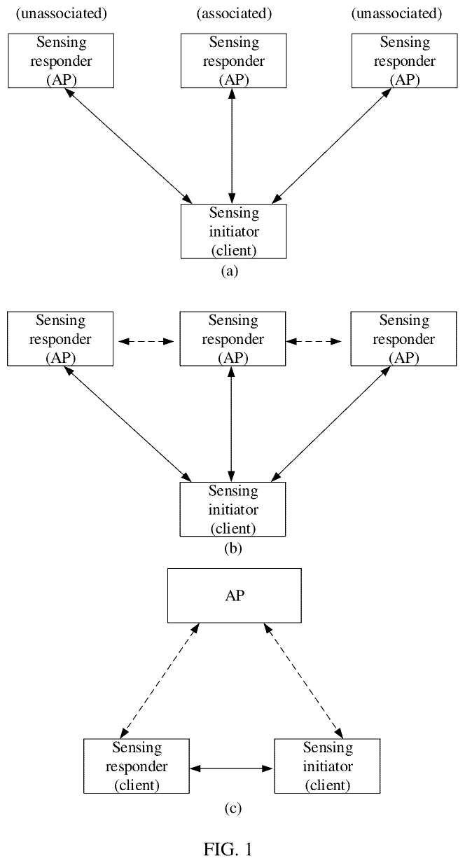

FIG. 1 shows an example approach of WLAN sensing.

The procedure of WLAN sensing may be as follows. An initiator initiates WLAN sensing (e.g., initiates a WLAN sensing session), and there may be multiple responders responding to the WLAN sensing. Specific possible methods may be shown in (a), (b) and (c) in FIG. 1.

Referring to (a) in FIG. 1, when a WLAN sensing initiator (e.g., a client) initiates WLAN sensing, multiple associated or unassociated WLAN sensing responders (e.g., three Access Points (APs)) may make response. Here, “associated” may refer to that an associated connection for communication is established between an initiator and a responder, and “unassociated” may refer to that no associated connection for communication is established between the initiator and the responder.

By way of example, the client may include, but is not limited to, a cellular phone, a smart phone, a wearable device, a computer, a Personal Digital Assistant (PDA), a Personal Communication System (PCS) device, a Personal Information Manager (PIM), a Personal Navigation Device (PND), a global positioning system, a multimedia device, or an Internet of Things (IoT) device, etc.

An AP may be a wireless switch for a wireless network or an access device for a wireless network. The AP may include software application(s) and/or circuit(s) to enable other types of nodes in the wireless network to communicate with the outside and inside of the wireless network through the AP. As an example, the AP may be a terminal device or a network device equipped with a Wireless Fidelity (Wi-Fi) chip.

The (b) in FIG. 1 is similar to (a) in FIG. 1, but as shown in (b) in FIG. 1, responders (AP) can communicate with each other.

Referring to (c) in FIG. 1, both the WLAN sensing initiator and WLAN sensing responder may be clients, and the both may communicate by connecting to the same AP.

Although (a), (b) and (c) in FIG. 1 show that the client serves as the initiator and the AP(s) serves (serve) as the responder(s), the present disclosure is not limited thereto. For example, in various embodiments of the present disclosure, an AP may serve as the initiator and a client may serve as the responder. In addition, in various embodiments of the present disclosure, the client may also be referred to as a non-AP station (non-AP STA), referred to as a “station (STA)” for short. In addition, the number of initiators and responders is not limited to that shown in (a), (b) and (c) in FIG. 1.

As an illustrative embodiment, the procedure of WLAN sensing initiated by the initiator may include one or more of the following phases: a sensing session setup phase, a sensing measurement setup phase, a sensing measurement phase, a sensing measurement reporting phase and a termination phase.

In the sensing session setup phase, a sensing measurement session may be established, and operational parameter(s) associated with the sensing session may be determined and exchanged between devices. In the sensing measurement setup phase, the initiator and responder(s) may establish one or more sensing measurement procedures, and each sensing measurement setup may be identified by a measurement setup ID. A sensing measurement session may correspond to one or more sensing measurement setups. In the sensing measurement phase, a sensing measurement instance may be performed based on a sensing measurement frame. The sensing measurement reporting phase may be referred to as a reporting phase for short. In this phase, a sensing measurement result may be reported, for example, Channel State Information (CSI) may be reported. In the termination phase, the sensing measurement may be stopped and the sensing session may be terminated.

It should be understood that the procedure of WLAN sensing described above is merely illustrative, and some phases in the procedure may be omitted or combined.

In the WLAN sensing technologies, a trigger-based (TB-based) sensing method is proposed. For example, in the TB-based sensing method, a threshold-based reporting method can be used in the reporting phase. However, in the current researches, the mechanism of the threshold-based reporting method still needs further improvements.

In view of this, according to the concept of the embodiments of the present disclosure, a communication method and a communication apparatus for sensing measurement reporting are provided.

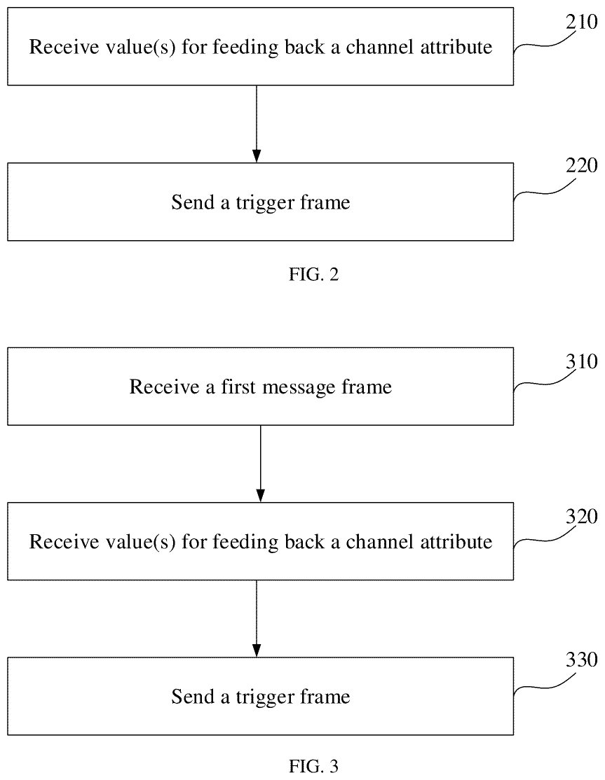

FIG. 2 is a flowchart showing a communication method according to an example embodiment. The communication method shown in FIG. 2 may be applied in an access point device (may be referred to as “access point” or “AP” for short in the present disclosure).

Referring to FIG. 2, in step 210, the AP may receive value(s) for feeding back a channel attribute from one or more station devices (hereinafter referred to as “stations” or “STAs”). The value(s) received by the AP may be value(s) about the channel attribute measured by the one or more station devices. For example, but not limited to, the value(s) for feeding back the channel attribute may be a channel state information (CSI) value. For example, the AP may receive CSI value(s) measured by one or more station devices, respectively. For example, but not limited to, the value(s) for feeding back the channel attribute may be quantized CSI value(s). For example, the AP may receive quantized CSI value(s) calculated by one or more station devices, respectively.

In step 220, the AP may compare the received value(s) with a threshold to determine whether to send a trigger frame. Specifically, based on at least one of the received value(s) being greater than or equal to the threshold, a trigger frame is sent to at least one station device of the one or more station devices to trigger the at least one station device to report a sensing measurement result. For example, the AP may compare the received CSI value(s) or the quantized CSI value(s) with the threshold, and send a trigger frame when the CSI value(s) or the quantized CSI value(s) is (are) greater than or equal to the threshold. For example but not limited to, the sensing measurement result may also be a CSI value or a quantized CSI value.

In an embodiment of the present disclosure, the AP may set a different threshold for each of the one or more station devices. That is, a value (e.g., a CSI value) received from a specific station device is compared with its corresponding threshold to determine whether to send a trigger frame to the specific station device to trigger the specific station device to report (send) a sensing measurement result to the AP. In another embodiment of the present disclosure, the AP may set the same threshold for each of the one or more station devices. That is, values (e.g., CSI values) received from all station devices are compared with the threshold to determine whether to send a trigger frame to the station devices. However, the present disclosure is not limited to this. For example, the AP may set different thresholds for a part of the one or more station devices, and set the same threshold for another part of the one or more station devices. Setting thresholds in different ways can increase the flexibility and adaptability of the system and the accuracy of the sensing measurement.

For example, when the AP sends a trigger frame, the AP may, according to a comparison result with the threshold, send a trigger frame to a station device from which a CSI value or a quantized CSI value greater than or equal to the threshold is received, so that the sensing measurement result can be received from the station device that receives the trigger frame.

In the communication method shown in FIG. 2, after the AP compares the value(s) fed back by the STA(s) with the threshold in step 210, it determines whether to trigger STA(s) to report a sensing measurement result in step 220, which helps to save signaling in subsequent sensing measurement. For example, for a STA which in step 210 feeds back a value less than the threshold, the STA may not feed back a sensing measurement result, or the STA may not participate in subsequent sensing measurement, thereby saving signaling.

The communication method according to the embodiment of the present disclosure improves the mechanism of the threshold-based reporting method, making it applicable to WLAN sensing measurement.

In the embodiment shown in FIG. 2, although the AP sets a threshold for comparison, the threshold may not be carried in the trigger frame sent to a station device. However, the present disclosure is not limited to the embodiment shown in FIG. 2.

For example, in a communication method for sensing measurement reporting provided in the present disclosure, the communication method may be applied in an access point device and may include: receiving value(s) for feeding back a channel attribute from one or more station devices, respectively; and based on at least one of the received value(s) being greater than or equal to a threshold, sending a trigger frame to at least one station device of the one or more station devices to trigger at least one station device to report a the sensing measurement result, wherein the trigger frame may include information about the threshold.

For example, the trigger frame may include the threshold, and the threshold is set for each of the one or more station devices, and the threshold is configured to enable the one or more station devices to determine whether to report the sensing measurement result. In other words, the AP may carry a specific threshold in the trigger frame so that a station device receiving the trigger frame knows the threshold set (allocated) for the station device. Here, the AP may set a different threshold or the same value for each of the one or more station devices, which has been described in the above embodiments, and repeated descriptions are omitted to avoid redundancy.

According to an embodiment of the present disclosure, the threshold may be a channel state information threshold (i.e., a CSI threshold) or a quantized channel state information threshold (i.e., a quantized CSI threshold). For example, the value(s) for feeding back the channel attribute and the sensing measurement result(s) received by the AP from the station device(s) may be CSI values, and the CSI values may be compared with the CSI threshold. For example, the value(s) for feeding back the channel attribute and the sensing measurement result(s) received by the AP from the station device(s) may be quantized CSI values, and the quantized CSI values may be compared with the quantized CSI threshold. A CSI value may refer to a CSI value obtained by the station device through directly performing measurement, and the CSI threshold may be set for the CSI value. The AP may receive the CSI value to intuitively obtain the channel attribute of a corresponding station device. A quantized CSI value may refer to a value obtained by quantizing a measured CSI value, and the quantized CSI threshold may be set for the quantized CSI value. For example, if the CSI value obtained by measurement of a station is A, and the unit used for quantization (or referred to as “quantization ratio”) is U, then the quantized CSI value may be A/U. In this way, since the quantized CSI value and the quantized CSI threshold set for the quantized CSI value occupy fewer bytes, the resources required for transmitting the CSI value or the CSI threshold can be saved, and the power consumption can be reduced. In the embodiment of the present disclosure, the unit used for quantization (or referred to as “quantization ratio”) can be pre-negotiated and determined between an AP and a station device.

In addition, in an optional embodiment, in a communication method for sensing measurement reporting provided by the present disclosure, the communication method may be applied in an access point device, the trigger frame includes a threshold, the threshold is set for each of one or more station devices, and the threshold is also configured to enable one or more station devices to determine whether to report a sensing measurement result. And, the trigger frame may include threshold existence bit(s). The threshold existence bit(s) is (are) configured to indicate that the trigger frame includes the threshold. For example, a station device receiving the trigger frame may first parse the threshold existence bit(s) to determine whether the trigger frame includes the threshold. When it is determined by the threshold existence bit(s) that the trigger frame includes the threshold, the trigger frame can be further parsed to obtain a specific threshold, which helps to ensure the accuracy of the transmission and parsing of the trigger frame. According to an embodiment of the present disclosure, the existence of the threshold (for example, the existence of the CSI threshold or the quantized CSI threshold) can be indicated by at least one bit in the trigger frame. In other words, the threshold existence bit(s) may have at least one bit. For example, the threshold existence bit(s) may have one bit. When the bit is set to a first value (for example, but not limited to “1”), it indicates that the threshold exists; and when the bit is set to a second value (for example, but not limited to “0”), it indicates that the threshold does not exist. For another example, the threshold existence bit(s) may have more bits to indicate the specific number of thresholds included in the trigger frame. However, the present disclosure is not limited to this, and the threshold existence bit(s) may also be omitted, and only the threshold is included in the trigger frame.

Although the trigger frame may not carry a threshold in the embodiment shown in FIG. 2, the trigger frame may carry other information to trigger a station device to send a sensing measurement result.

For example, in a communication method for sensing measurement reporting provided by the present disclosure, the communication method may be applied to an access point device and may include: receiving value(s) for feeding back a channel attribute from one or more station devices, respectively; and based on at least one of the received value(s) being greater than or equal to a threshold, sending a trigger frame to at least one station device of the one or more station devices to trigger at least one station device to report a sensing measurement result, wherein the trigger frame may include a sensing measurement setup identifier (measurement setup ID), wherein the sensing measurement setup identifier is configured to identify a sensing measurement procedure for which a sensing measurement result needs to be reported. For example, as described in the above embodiments, in the sensing measurement setup phase, the sensing measurement procedure can be identified by using the measurement setup identifier. Therefore, in the sensing measurement reporting phase, when an AP sends a trigger frame including a sensing measurement setup identifier to a STA, the STA can report to the AP a sensing measurement result in a sensing measurement procedure corresponding to the included sensing measurement setup identifier.

For example, in a communication method for sensing measurement reporting provided by the present disclosure, the communication method may be applied in an access point device and may include: receiving value(s) for feeding back a channel attribute from one or more station devices, respectively; and based on at least one of the received value(s) being greater than or equal to a threshold, sending a trigger frame to at least one station device of the one or more station devices to trigger at least one station device to report a sensing measurement result, wherein the trigger frame may include one or more station identifiers, and the one or more station identifiers identify one or more station devices, respectively. For example, the station identifier may be identified by using an Association Identifier (AID) or a Un-association Identifier (UID). The AID may represent an identifier of a station with which an associated communication is established with the AP, and the UID represents an identifier of a station with which an associated communication is not established with the AP. For example, when the AP sends a trigger frame including one or more AIDs or UIDs to one or more STAs, the STAs that receive the trigger frame can parse the trigger frame to determine whether the trigger frame includes their own AIDs or UIDs, and if a STA determines that the trigger frame includes its own AID or UID, the STA report its sensing measurement result to the AP.

Although the information that may be included in the trigger frame is described separately in each of the above embodiments, it will be understood that the above embodiments may be combined in various manners.

For example, in an optional embodiment, in a communication method for sensing measurement reporting provided by the present disclosure, the communication method may be applied to an access point device, a trigger frame includes a threshold, the threshold is set for each of one or more station devices, and the threshold is also configured to enable one or more station devices to determine whether to report a sensing measurement result. And, the trigger frame may include a sensing measurement setup identifier. The threshold (for example, a CSI threshold or a quantized CSI threshold) may correspond to the sensing measurement setup identifier, thereby identifying the threshold set for the sensing measurement procedure corresponding to the corresponding sensing measurement setup identifier. For example, when a threshold B corresponds to a first sensing measurement setup identifier in the trigger frame, for the sensing measurement procedure corresponding to the first sensing measurement setup identifier, if a sensing measurement result measured by a station device receiving the trigger frame is greater than or equal to the threshold B, the station device reports (sends) the sensing measurement result to the AP.

However, the present disclosure is not limited to the above examples, and the sensing measurement setup identifier may be omitted, or the threshold existence bit(s) may be included in the trigger frame.

For example, in an optional embodiment, in a communication method for sensing measurement reporting provided by the present disclosure, the communication method may be applied to an access point device, a trigger frame includes a threshold, the threshold is set for each of one or more station devices, and the threshold is also configured to enable one or more station devices to determine whether to report a sensing measurement result. And, the trigger frame may include one or more station identifiers. The station identifiers (e.g., AIDs/UIDs) in the trigger frame may correspond to the threshold (e.g., the CSI threshold or the quantized CSI threshold) in the trigger frame. For example, the threshold (e.g., the CSI threshold or the quantized CSI threshold) set for each STA may be different. By making the threshold corresponding to the station identifier of the STA, the corresponding STA can clearly know its own threshold, and when the sensing measurement result of the corresponding STA is greater than or equal to its threshold, the sensing measurement result is reported to the AP.

However, the present disclosure is not limited to the above examples, and the station identifiers may also be omitted, or the threshold existence bit(s) and/or the sensing measurement setup identifier may be included in the trigger frame.

The above embodiments describe various information included in the trigger frame. It will be understood that various modifications may be made to the above embodiments, and embodiments obtained by combining the above embodiments also fall within the scope of the present disclosure.

The communication methods according to the embodiments of the present disclosure improve the mechanism of the threshold-based reporting method. For example, in the case of CSI threshold-based reporting, the format of the trigger frame sent by the AP is improved to make it suitable for WLAN sensing measurement.

According to an embodiment of the present disclosure, various information included in the trigger frame may be included in various information fields in the trigger frame. For example, after receiving CSI fed back by a STA, if the AP finds that the CSI value is higher than a defined CSI threshold, the AP sends a trigger frame. For example, at least one bit (such as the “threshold existence bit(s)” described in the above embodiments) is included in the common information (common info) field of the trigger frame to indicate the existence of the CSI threshold or the existence of the quantized CSI threshold, so that the STA can report the sensing measurement result according to the CSI threshold or the quantized CSI threshold. In addition, a sensing measurement setup identifier subfield is included in the common information (info) field. The sensing measurement setup identifier subfield identifies a specific sensing measurement procedure for which that a sensing measurement result needs to be fed back. In addition, since the CSI threshold or quantized CSI threshold set for each STA may be different, the CSI threshold or quantized CSI threshold may be included in the station information (STA info) field in the trigger frame, and the AID/UID of the STA may correspond to its CSI threshold or quantized CSI threshold, thereby indicating that the STA needs to report the sensing measurement result when it is above the threshold. It should be understood that the embodiments described herein are only illustrative and not intended to limit the present disclosure, and various information may be carried in the trigger frame in different other ways.

FIG. 3 is a flowchart showing a communication method according to an example embodiment. The communication method shown in FIG. 3 may be applied in an access point device.

Referring to FIG. 3, in step 310, the AP may receive a first message frame from one or more station devices, respectively, wherein the first message frame may include a bit indicating that a corresponding station device supports threshold-based sensing measurement reporting. The bit in the first message frame may indicate the station device's support capability for threshold-based sensing measurement reporting (e.g., supporting CSI threshold-based feedback).

For example, step 310 may be performed during the sensing session setup procedure described with reference to FIG. 1 or during a sensing discovery procedure. For example, the first message frame may be a response frame with respect to a frame for sensing session setup (which may be referred to as a “sensing session setup frame”) sent by the AP, and the station device may indicate in the response frame that the station device supports CSI threshold-based feedback and send the response frame (first message frame) to the AP. Specifically, in the sensing session setup procedure, the bit may be included in the form of an information element; or, in the sensing discovery procedure, a bit in the extended capabilities information element may be configured to indicate that the station device supports CSI threshold-based feedback. According to an embodiment of the present disclosure, indicating the CSI threshold capability information in advance facilitates the order and accurate execution of WLAN sensing measurement.

In addition, although not shown in the drawings, as an optional embodiment, the unit (quantization ratio) for quantization may also be negotiated during the sensing session setup procedure or the sensing discovery procedure. For example, an AP and a STA may pre-negotiate the unit (quantization ratio) for quantization through the sensing session setup frame and the response frame, so that the CSI value may be quantized based on the unit (quantization ratio) for quantization and the quantized CSI threshold may be set in the subsequent sensing measurement reporting phase.

In step 320, the AP may receive value(s) (e.g., CSI value(s) or quantized CSI value(s)) for feeding back a channel attribute from one or more station devices, respectively. In step 330, the AP may, based on at least one of the received value(s) being greater than or equal to a threshold, send a trigger frame to at least one station device of the one or more station devices to trigger at least one station device to report a sensing measurement result. Steps 320 and 330 in FIG. 3 may be operations performed in the sensing measurement reporting phase, and their specific contents have been described in detail with reference to FIG. 2 and various modified embodiments. For the sake of simplicity, repeated descriptions are omitted here.

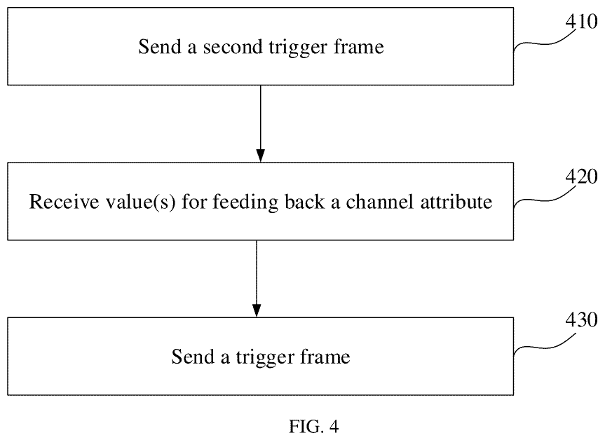

FIG. 4 is a flowchart showing a communication method according to an example embodiment. The communication method shown in FIG. 4 may be applied in an access point device.

Referring to FIG. 4, in step 410, the AP may send a second message frame to one or more station devices, respectively, wherein the second message frame is configured to trigger the one or more station devices to send a value (e.g., a CSI value or a quantized CSI value) for feeding back a channel attribute. For example, the second message frame may be a trigger frame, which is configured to trigger a station device that receives the trigger frame to send a CSI value or a quantized CSI value.

In step 420, the AP may receive value(s) (e.g., CSI value(s) or quantized CSI value(s)) for feeding back a channel attribute from one or more station devices, respectively. In other words, the one or more station devices may send, for example, CSI values or quantized CSI values to the AP in response to the trigger of the second message frame (trigger frame) from the AP in step 410.

In step 430, based on at least one of the received values being greater than or equal to a threshold, the AP may send a trigger frame to at least one station device of the one or more station devices to trigger the at least one station device to report a sensing measurement result.

Step 420 and step 430 in FIG. 4 may be operations performed in the sensing measurement reporting phase, and their specific contents have been described in detail with reference to FIG. 2 and various modified embodiments. For the sake of brevity, repeated descriptions are omitted here.

In addition, although FIG. 4 shows that step 410 is included, the present disclosure is not limited to this. For example, step 410 may be omitted (i.e., the communication method shown in FIG. 2). In this case, for example, the AP may periodically receive CSI value(s) or quantized CSI value(s) from one or more station devices to determine whether each station device needs to report a sensing measurement result.

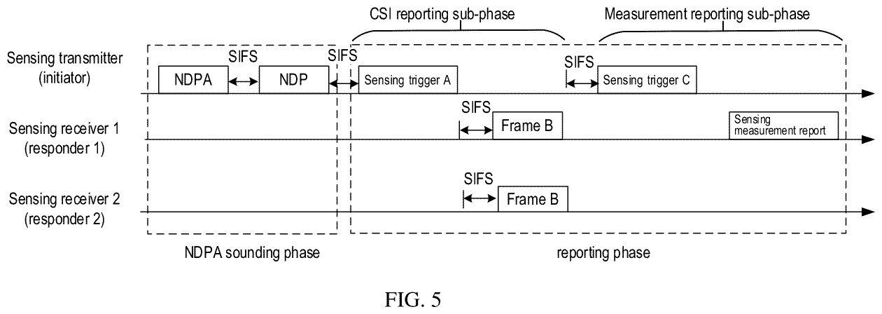

FIG. 5 is a flowchart illustrating an interaction according to an example embodiment.

The embodiment of FIG. 5 shows a sensing measurement phase (NDPA sounding phase) and a sensing measurement reporting phase (reporting phase).

Referring to FIG. 5, in the NDPA sounding phase, an initiator (i.e., AP) may send a Null Data Packet Announcement (NDPA) frame and a Null Data Packet (NDP) frame to a responder 1 (i.e., a first station) and a responder 2 (a second station) for the responder 1 and responder 2 to perform sensing measurement. For example, the NDPA frame may be configured to indicate channel occupancy and/or carry information about the NDP frame. For example, the NDP frame may be used for sensing measurement, for example but not limited to, the NDP frame may include operating parameters required for performing WLAN sensing measurement, such as the number of spatial streams, the operating bandwidth of the NDP frame, the Long Training Field (LTF), the Packet Extension (PE) field, and the like. Although not shown, the responder 1 and responder 2 may perform sensing measurement to obtain CSI values or quantized CSI values. In addition, in an embodiment of the present disclosure, the initiator that sends the NDPA frame and the NDP frame may also be referred to as a sensing transmitter, and the responder 1 and the responder 2 that receive the NDPA frame and the NDP frame may also be referred to as a sensing receiver 1 and a sensing receiver 2.

The reporting phase in FIG. 5 may also be referred to as a threshold-based reporting phase, which may include a CSI reporting sub-phase and a measurement reporting sub-phase. The “Short interframe space (SIFS)” in FIG. 5 may refer to the time interval between frames.

In the CSI reporting sub-phase, the initiator AP may send a sensing trigger A (e.g., the second message frame in step 410 of FIG. 4) to the responder 1 and the responder 2. The responder 1 and the responder 2 may send a frame B (i.e., the trigger frame in step 210 of FIG. 2, step 320 of FIG. 3, and step 420 of FIG. 4) to the initiator AP in response to the sensing trigger A. The frame B may include a value for feeding back a channel attribute (e.g., a CSI value or a quantized CSI value). For example, the frame B sent by the responder 1 may include the CSI value or the quantized CSI value of the responder 1, and the frame B sent by the responder 2 may include the CSI value or the quantized CSI value of the responder 2.

Although not shown, in the case where the initiator AP receives the frames B from the responder 1 and the responder 2, respectively, the initiator AP may compare the CSI value or quantized CSI value of the responder 1 with a first threshold (the threshold set for the responder 1) to determine whether the responder 1 needs to feed back a sensing measurement result; and the initiator AP may compare the CSI value or quantized CSI value of the responder 2 with a second threshold (the threshold set for the responder 2) to determine whether the responder 2 needs to feed back a sensing measurement result. As in the embodiments described above, the first threshold and the second threshold may be different CSI thresholds or quantized CSI thresholds set for the responder 1 and the responder 2, respectively, or the first threshold and the second threshold may be the same CSI threshold or quantized CSI threshold.

In the measurement reporting sub-phase, the initiator AP may send a sensing trigger C based on the comparison results. In an embodiment of the present disclosure, the initiator AP may send a sensing trigger C to the responder 1. For example, the initiator AP may send a sensing trigger C (i.e., the trigger frame in step 220 of FIG. 2, step 330 of FIG. 3, and step 430 of FIG. 4) to the responder 1 based on the CSI value or quantized CSI value of the responder 1 being greater than or equal to the first threshold. The responder 1 may send a sensing measurement report to the initiator AP in response to the sensing trigger C, and the sensing measurement report may be the CSI threshold or quantized CSI threshold of the responder 1. That is, the initiator AP may determine the CSI threshold or quantized CSI threshold for each responder for comparison with the CSI value or quantized CSI value, but may not send the CSI threshold or quantized CSI threshold to the responder.

In another embodiment of the present disclosure, the initiator AP may send a sensing trigger C to the responder 1 and the responder 2, and the sensing trigger C carries threshold information about the responder 1 (e.g., the first threshold) and threshold information about the responder 2 (e.g., the second threshold). When receiving the sensing trigger C, the responder 1 and the responder 2 may obtain their respective thresholds and compare their respective sensing measurement results (CSI values or quantized CSI values) with the corresponding thresholds. For example, the responder 1 may compare its sensing measurement result (CSI value or quantized CSI value) with the first threshold, and if it is determined that its sensing measurement result (CSI value or quantized CSI value) is greater than or equal to the first threshold, the responder 1 sends a sensing measurement report to the initiator AP. For example, the responder 2 may compare its sensing measurement result (CSI value or quantized CSI value) with the second threshold, and if it is determined that its sensing measurement result (CSI value or quantized CSI value) is less than the second threshold, the responder 2 does not send a sensing measurement report to the initiator AP. That is, the initiator AP can determine the CSI threshold or quantized CSI threshold for each responder for comparison with the CSI value or quantized CSI value, and can send the CSI threshold or quantized CSI threshold to each sensing receiver through a trigger frame (sensing trigger C).

It should be understood that the interaction flowchart shown in FIG. 5 is only an illustrative example, and is not a limitation of the present disclosure, and various modifications may be made to the interaction flowchart of FIG. 5. For example, the sensing measurement phase may also adopt other sounding methods (e.g., trigger frame (TF) sounding); for another example, in the sensing measurement reporting phase, some operations may be omitted, or more frame interaction operations may be included.

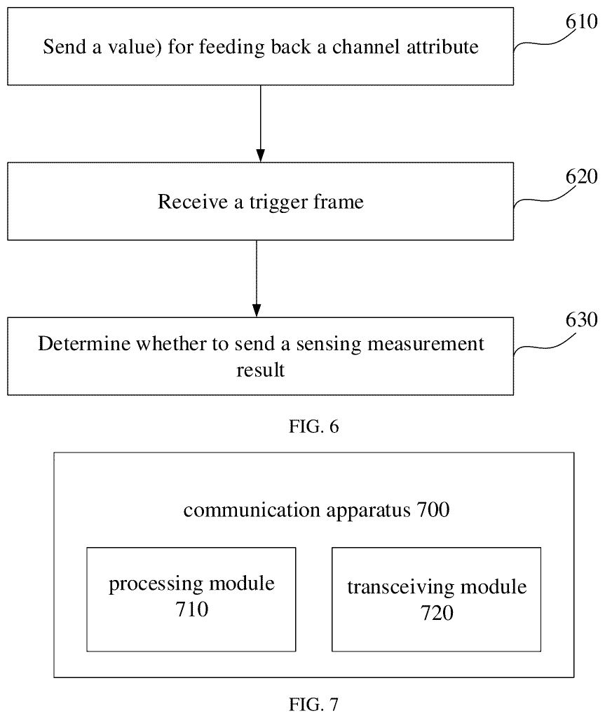

FIG. 6 is a flowchart showing another communication method according to an example embodiment. The communication method shown in FIG. 6 may be applied in a station equipment (STA).

Referring to FIG. 6, in step 610, the STA may send a value (e.g., a CSI value or a quantized CSI value) for feeding back a channel attribute to an access point device.

In step 620, the STA may receive a trigger frame sent by the access point device, wherein the trigger frame is determined to be sent based on the value being greater than or equal to a threshold.

Step 610 and step 620 may correspond to step 210 and step 220 of FIG. 2, respectively. The embodiments described with reference to FIG. 2 and its various modified embodiments may also be applied here. For the sake of brevity, repeated descriptions are omitted.

In step 630, the STA may determine whether to send a sensing measurement result to the access point device based on the trigger frame. For example, if the STA receives a trigger frame that does not carry a threshold, the STA may send the sensing measurement result to the AP in response to the trigger frame. For example, if the STA receives a trigger frame that carries a threshold, the STA may parse the trigger frame to know the threshold set for the STA, compare the threshold with its sensing measurement result, and determine whether to send the sensing measurement result to the AP based on the comparison result. For example, when the sensing measurement result of the STA is greater than or equal to its threshold, it may be determined in step 630 to send the sensing measurement result to the AP; when the sensing measurement result of the STA is less than its threshold, it may be determined in step 630 not to send the sensing measurement result to the AP.

Optionally, the trigger frame may include a threshold, the threshold may be set for each of the one or more station devices (the threshold set for each station device may be the same or different), and the threshold is configured to enable the one or more station devices to determine whether to report the sensing measurement result.

Optionally, the threshold for each station device may be a channel state information threshold or a quantized channel state information threshold.

Optionally, the trigger frame may include threshold existence bit(s), and the threshold existence bit(s) may be configured to indicate that the trigger frame includes the threshold.

Optionally, the trigger frame may include a sensing measurement setup identifier, and the sensing measurement setup identifier may be configured to identify a sensing measurement procedure for which a sensing measurement result needs to be reported.

Optionally, the trigger frame may include one or more station identifiers, and the one or more station identifiers may identify one or more station devices, respectively.

The various information included in the trigger frame has been described above, and repeated description is omitted here to avoid redundancy.

Optionally, the communication method may further include (not shown): the STA sends a first message frame to the access point device, wherein the first message frame may include a bit indicating that the station device supports threshold-based sensing measurement reporting. This may be corresponding to the embodiment described with reference to FIG. 3, and the descriptions regarding the embodiment described with reference to FIG. 3 may also be applied here, and repeated descriptions are omitted for simplicity.

Optionally, the communication method may further include (not shown): the STA receives a second message frame, wherein the second message frame may be configured to trigger the station device(s) to send value(s) for feeding back a channel attribute, respectively. This may be corresponding to the embodiment described with reference to FIG. 4, and the descriptions regarding the embodiment described with reference to FIG. 4 may also be applied here, and repeated descriptions are omitted for simplicity.

The communication method according to the embodiment of the present disclosure improves the mechanism of the threshold-based reporting method (for example, improves the setting of the CSI threshold and the sending and format of the trigger frame) to make it suitable for WLAN sensing measurement.

FIG. 7 is a block diagram showing a communication apparatus according to an example embodiment. The communication apparatus 700 of FIG. 7 may include a processing module 710 and a transceiving module 720. In an embodiment of the present disclosure, the communication apparatus 700 shown in FIG. 7 may be applied in an access point device. In another embodiment of the present disclosure, the communication apparatus 700 shown in FIG. 4 may be applied in a station device.

In a case where the communication apparatus 700 shown in FIG. 7 may be applied in an access point device, the processing module 710 may be configured to perform various processing operations, such as parsing information received by the transceiving module 720, processing the received information (e.g., comparing the feedback value with a threshold), and determining the information or frame to be sent by the AP (e.g., determining the threshold), etc.; the transceiving module 720 may be configured to: receive value(s) for feeding back a channel attribute from one or more station devices respectively; and based on at least one of the received value(s) being greater than or equal to the threshold, send a trigger frame to at least one of the one or more station devices to trigger at least one station device to report a sensing measurement result. The communication apparatus 700 shown in FIG. 7 can perform the communication methods described with reference to FIGS. 2 to 4 and the operations performed by the initiator in FIG. 5, and the descriptions regarding the embodiments described with reference to FIGS. 2 to 4 can be applied here. In order to avoid redundancy, repeated descriptions are omitted here.

In a case where the communication apparatus 700 shown in FIG. 7 may be applied to a station device, the transceiving module 720 may be configured to: send a value for feeding back a channel attribute to an access point device; and receive a trigger frame sent by the access point device, wherein the trigger frame is determined to be sent based on the value being greater than or equal to a threshold; the processing module 710 may be configured to: determine whether to send a sensing measurement result to the access point device based on the trigger frame. That is, the communication apparatus 700 shown in FIG. 7 can perform the communication method described with reference to FIG. 6 and the operation performed by the responder in FIG. 5, and the descriptions regarding the embodiment described with reference to FIG. 6 can be applied thereto, and in order to avoid redundancy, repeated descriptions are omitted here.

It should be understood that the communication apparatus 700 shown in FIG. 7 is illustrative only, and the embodiments of the present disclosure are not limited thereto. For example, the communication apparatus 700 may also include other modules, such as a memory module, etc. The memory module may be configured to store various information and data in the communication operations, such as storing information about the threshold. In addition, the various modules in the communication apparatus 700 may be combined into a more complex module, or may be divided into more separate modules.

The communication methods and the communication apparatuses according to the embodiments of the present disclosure improve the mechanism of the threshold-based reporting method (for example, improve the setting of the CSI threshold and the sending and format of the trigger frame), making the threshold-based reporting method suitable for WLAN sensing measurement.

Based on the same principle as the methods provided by the embodiments of the present disclosure, an embodiment of the present disclosure also provides an electronic apparatus, which includes a processor and a memory. The memory stores machine-readable instructions (also referred to as “computer programs”). The processor is configured to execute the machine-readable instructions to implement the methods described with reference to FIGS. 2 to 6.

An embodiment of the present disclosure further provides a computer-readable storage medium having a computer program stored thereon. When the computer program is executed by a processor, the methods described with reference to FIGS. 2 to 6 are implemented.

In an example embodiment, the processor may be configured to implement or execute various example logic blocks, modules and circuits described in conjunction with the contents in the present disclosure, for example, a Central Processing Unit (CPU), a general-purpose processor, a Digital Signal Processor (DSP), an Application Specific Integrated Circuit (ASIC), a Field Programmable Gate Array (FPGA), or other programmable logic device, transistor logic device, hardware component, or any combination thereof. The processor may also be a combination that implements computing functions, such as a combination of one or more microprocessors, a combination of a DSP and a microprocessor, and the like.

In an example embodiment, the memory may be, for example, a Read Only Memory (ROM), a Random Access Memory (RAM), an Electrically Erasable Programmable Read Only Memory (EEPROM), a Compact Disc Read Only Memory (CD-ROM), or other optical disk storage, optical disk storage (including compact disc, laser disc, optical disc, digital versatile disc, Blu-ray disc, etc.), magnetic disk storage medium or other magnetic storage device, or any other medium that can be used to carry or store program codes in the form of instructions or data structures and can be accessed by a computer, but the present disclosure is not limited to these examples.

It should be understood that, although the steps in the flowcharts of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. In addition, at least a portion of the steps in the flowcharts of the accompanying drawings may include multiple sub-steps or multiple stages, and these sub-steps or stages are not necessarily executed at the same time, but can be executed at different times, and their execution order is not necessarily sequential, but they can be executed in turn or alternately with other steps or at least a portion of the sub-steps or stages of other steps.

Although the present disclosure has been shown and described with reference to certain embodiments of the present disclosure, it should be appreciated by those skilled in the art that various changes may be made in form and details without departing from the scope of the present disclosure. Therefore, the scope of the present disclosure should not be limited to the embodiments, but should be limited by the appended claims and their equivalents.

1. A communication method for sensing measurement reporting, wherein the method is performed by an access point (AP) and comprises:
receiving values for feeding back a channel attribute from one or more stations respectively; and
based on at least one of the values greater than or equal to a threshold, sending a trigger frame to at least one station of the one or more stations to trigger the at least one station to report a sensing measurement result.

2. The communication method according to claim 1, wherein the trigger frame comprises the threshold,
wherein the threshold is set for each station of the one or more stations, and the threshold is configured to enable the one or more stations to determine whether to report the sensing measurement result.

3. The communication method according to claim 2, wherein the threshold for each station is a channel state information threshold or a quantized channel state information threshold.

4. The communication method according to claim 2, wherein the trigger frame comprises a threshold existence bit, wherein the threshold existence bit is configured to indicate that the trigger frame comprises the threshold.

5. The communication method according to claim 2, wherein the trigger frame comprises a sensing measurement setup identifier, wherein the sensing measurement setup identifier is configured to identify a sensing measurement procedure for which a sensing measurement result needs to be reported.

6. The communication method according to claim 2, wherein the trigger frame comprises one or more station identifiers, wherein the one or more station identifiers identify the one or more stations, respectively.

7. The communication method according to claim 1, further comprising:
receiving a first message frame from one or more stations respectively, wherein the first message frame comprises a bit configured to indicate a corresponding station supporting threshold-based sensing measurement reporting.

8. The communication method according to claim 1, further comprising:
sending a second message frame to the one or more stations respectively, wherein the second message frame is configured to trigger the one or more stations to send the value for feeding back the channel attribute respectively.

9. A communication method for sensing measurement reporting, wherein the method is applied in a station and comprises:
sending a value for feeding back a channel attribute to an access point (AP);
receiving a trigger frame sent by the AP, wherein the trigger frame is determined to be sent based on the value greater than or equal to a threshold; and
determining whether to send a sensing measurement result to the AP based on the trigger frame.

10. The communication method according to claim 9, wherein the trigger frame comprises the threshold,
wherein the threshold is set for each station of one or more stations, and the threshold is configured to enable one or more stations to determine whether to report a sensing measurement result.

11. The communication method according to claim 10, wherein the threshold for each station is a channel state information threshold or a quantized channel state information threshold.

12. The communication method according to claim 10, wherein the trigger frame comprises a threshold existence bit, wherein the threshold existence bit is configured to indicate that the trigger frame comprises the threshold.

13. The communication method according to claim 10, wherein the trigger frame comprises a sensing measurement setup identifier, wherein the sensing measurement setup identifier is configured to identify a sensing measurement procedure for which a sensing measurement result needs to be reported.

14. The communication method according to claim 10, wherein the trigger frame comprises one or more station identifiers, wherein the one or more station identifiers identify the one or more stations, respectively.

15. The communication method according to claim 9, further comprising:
sending a first message frame to the AP, wherein the first message frame comprises a bit configured to indicate the station supporting threshold-based sensing measurement reporting.

16. The communication method according to claim 9, further comprising:
receiving a second message frame, wherein the second message frame is configured to trigger the station to send the values for feeding back the channel attribute, respectively.

17. (canceled)

18. (canceled)

19. An electronic apparatus, comprising:
a processor; and
a memory storing a computer program executable by the processor,
wherein the processor is configured to:
receive values for feeding back a channel attribute from one or more stations respectively; and
based on at least one of the values greater than or equal to a threshold, send a trigger frame to at least one station of the one or more stations to trigger the at least one station to report a sensing measurement result.

20. A non-transitory computer-readable storage medium, wherein a computer program is stored on the computer-readable storage medium, and when the computer program is executed by a processor, the processor is caused to perform the communication method according to claim 1.

21. An electronic apparatus, comprising:
a processor; and
a memory storing a computer program executable by the processor,
wherein the processor is configured to perform the communication method according to claim 9.

22. A non-transitory computer-readable storage medium, wherein a computer program is stored on the computer-readable storage medium, and when the computer program is executed by a processor, the processor is caused to perform the communication method according to claim 9.
